(19) United States
(12) Patent Application Publication
(10) Pub. No.: US 2025/0073111 A1
(43) Pub. Date: Mar. 6, 2025

(54) Wearable Ankle Joint Motion Assist Device

(71) Applicants: Hyundai Motor Company, Seoul (KR); Kia Corporation, Seoul (KR)

(72) Inventors: Min Woong Jeung, Seoul (KR); Ju Young Yoon, Suwon-si (KR); Kuk Hyun Ahn, Seongnam-si (KR); Seung Jun Lee, Suwon-si (KR); Hyun Seop Lim, Anyang-Si (KR); Dong Hyun Lee, Ansan-Si (KR)

(21) Appl. No.: 18/426,775

(22) Filed: Jan. 30, 2024

(30) Foreign Application Priority Data
Sep. 1, 2023 (KR) 10-2023-0116052

(51) Int. Cl. A61H 1/02

(52) U.S. Cl. CPC A61H 1/0266; A61H 2201/1215; A61H 2201/14; A61H 2201/164; A61H 2205/12

(57) ABSTRACT

An ankle joint motion assist device may include a foot accommodating portion on which a user's foot may be accommodated; a driver connected to the foot accommodating portion and providing driving force for rotation of the foot accommodating portion; and a connector rotatably connecting the foot accommodating portion and the driver, wherein the connector may include a first connector to which the foot accommodating portion is coupled, and a second connector to which the driver is coupled, the first connector may be rotatably connected to the second connector about a first rotation axis and a second rotation axis, perpendicular to each other, the driver may include a pair of linear motor modules respectively connected to the first connector through a pair of linkers, and both end portions of the pair of linkers may be rotatably connected to the pair of linear motor modules and the first connector.

### CROSS-REFERENCE TO RELATED APPLICATION(S)

This application claims benefit of priority to Korean Patent Application No. 10-2023-0116052 filed on Sep. 1, 2023 in the Korean Intellectual Property Office, the disclosure of which is incorporated herein by reference in its entirety.

### 1. FIELD

The present disclosure relates to a wearable ankle joint motion assist device, and more specifically, to an ankle joint motion assist device assisting two-degree-of-freedom movement of an ankle.

### BACKGROUND

An ankle of the body may be capable of various joint degrees of freedom, bending movements, or the like, but conventional assist devices may not implement two-degree-of-freedom movement of the ankle and may provide only rotation of the ankle in flexion or extension, and there may be some portions that are difficult to assist in movement of the ankle in additional directions.

In addition, the body's ankle may have different rotational ranges of motion depending on the user, but conventional assist devices may operate regardless of the user's ankle range of motion, making it difficult to provide assistance optimized for the user's range of motion.

### SUMMARY

The following summary presents a simplified summary of certain features. The summary is not an extensive overview and is not intended to identify key or critical elements.

Systems, apparatuses, and methods are described for ankle joint motion assistance.

For example, aspects relate to an ankle joint motion assist device including a foot accommodating portion configured to accommodate a foot of a user. The device may further include a driver connected to the foot accommodating portion and configured to provide a driving force for rotation of the foot accommodating portion. The device may further include a connector rotatably connecting the foot accommodating portion and the driver. The connector may include a first connector to which the foot accommodating portion may be coupled, and a second connector to which the driver may be coupled. The first connector may be rotatably connected to the second connector about a first rotation axis and a second rotation axis, the first rotation axis and the second rotation axis may be perpendicular to each other. The drive may include a pair of linear motor modules connected to the first connector through a pair of linkers. End portions of the pair of linkers may be rotatably connected to the pair of linear motor modules.

Further aspects may relate to, for example, an ankle joint motion assist device including a foot accommodating portion configured to accommodate a foot of a user. The device may further include a driver connected to the foot accommodating portion and configured to provide driving force for roll movement and pitch movement of the foot accommodating portion. The device may further include a connector rotatably connecting the foot accommodating portion and the driver. The connector may include a first connector to which the foot accommodating portion may be coupled, a second connector to which the driver may be coupled, and a joint portion rotatably connecting the first connector and the second connector about a first rotation axis and a second rotation axis. The first rotation axis and the second rotation axis may be substantially perpendicular to each other. The foot accommodating portion may be configured to perform the roll movement as the first connector rotates, with respect to the second connector, about the first rotation axis. The foot accommodating portion may be configured to perform the pitch movement as the first connector rotates, with respect to the second connector, about the second rotation axis.

These and other features and advantages are described below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a front perspective view of an example ankle joint motion assist device.

FIG. 2 is a rear perspective view of an example ankle joint motion assist device.

FIG. 3 is a view illustrating a state in which an example ankle joint motion assist device is worn on a user's body.

FIG. 4 is an exploded perspective view of an example ankle joint motion assist device.

FIG. 5A is a front perspective view of a driver of an example ankle joint motion assist device.

FIG. 5B is a rear perspective view of a driver of an example ankle joint motion assist device.

FIG. 6A is a perspective view of a connector of an example ankle joint motion assist device.

FIG. 6B is a perspective view of a joint portion of a connector.

FIG. 7 is a plan view of a front surface of an example ankle joint motion assist device

FIG. 8 is a view illustrating a pitch operation of an example ankle joint motion assist device.

FIG. 9 is a view illustrating a roll operation of an example ankle joint motion assist device.

FIG. 10 is a perspective view of an example ankle joint motion assist device.

FIG. 11 is a view illustrating an operation of replacing a linker in an example ankle joint motion assist device.

FIGS. 12A and 12B are graphs illustrating a condition number for a case in which lengths of linkers are the same and a condition number for a case in which lengths of linkers are different, in an example ankle joint motion assist device.

### DETAILED DESCRIPTION

Because the present disclosure may have various changes and examples, specific examples may be illustrated in the drawings and described in detail. However, this may not be intended to limit the present disclosure to specific examples, it should be understood to include all modifications, equivalents and substitutes included in the spirit and scope of the present disclosure.

Terms such as first, second, etc. may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific examples, and may not be intended to limit the present disclosure. The singular expression may include the plural expression unless the context clearly dictates otherwise. In the present application, terms such as “comprise” or “have” may be intended to designate that a feature, number, step, operation, component, part, or combination thereof described in the specification exists, but one or more other features. It should be understood that this does not preclude the existence or addition of numbers, steps, operations, components, parts, or combinations thereof.

Unless defined otherwise, all terms used herein, including technical or scientific terms, include the same meaning as commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal meaning unless explicitly defined in the present application.

Recently, the development of a wearable assist device for the disabled, a patient, or an elderly person having physical abilities making everyday life difficult, or a wearable assist device for industrial or military use to enhance physical strength or physical ability is in progress. This wearable muscle strength assist device may be a type of robot having a multi-joint skeletal structure, and may serve to enhance a user's muscle strength when walking in a state of being worn on a lower body. The assist device may assist the user's walking and exercise by providing the user with auxiliary force generated by a driving device such as a motor or the like.

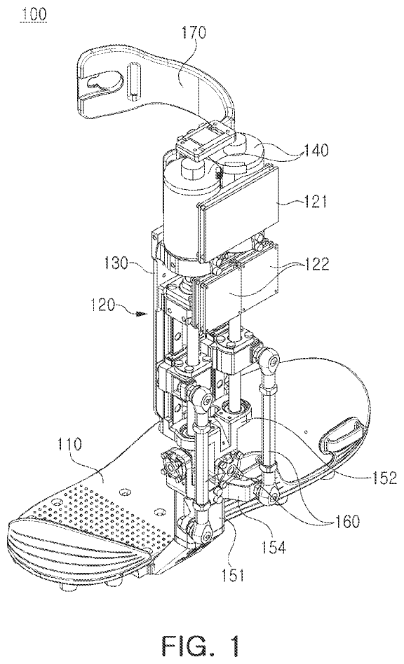

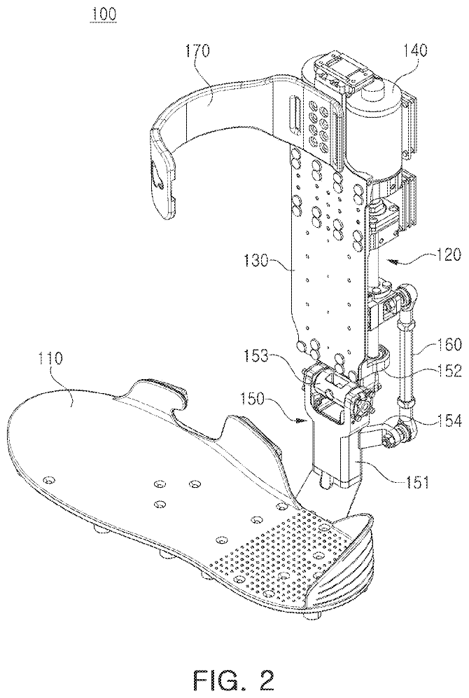

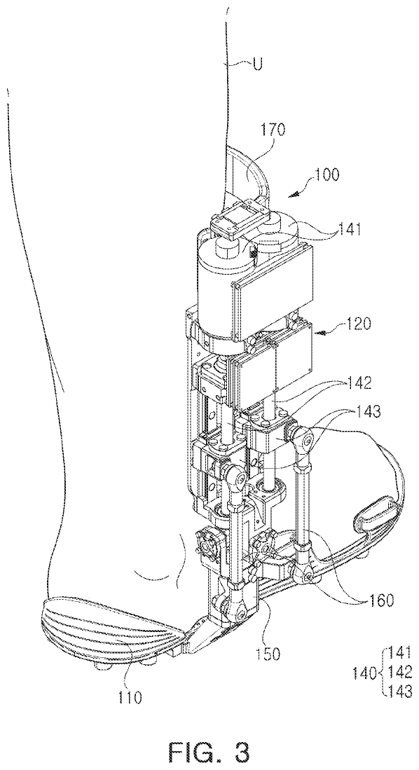

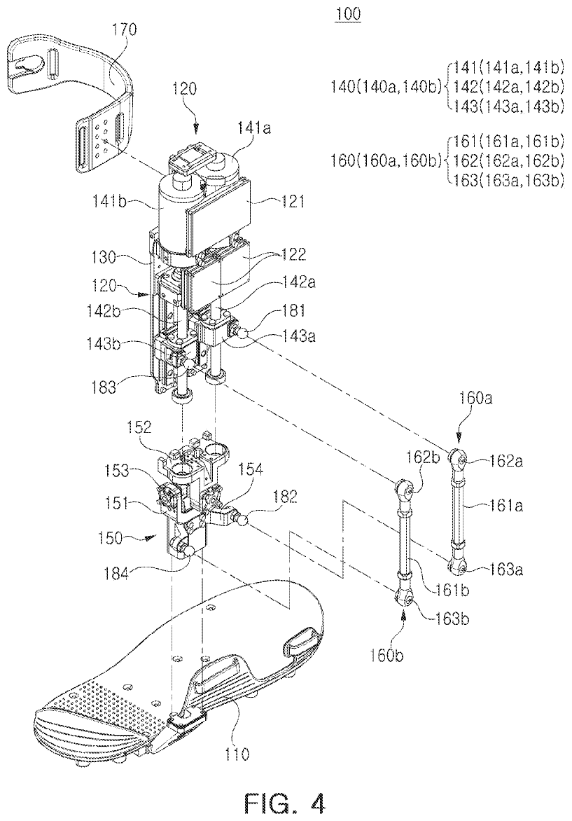

FIG. 1 is a front perspective view of an example ankle joint motion assist device 100. FIG. 2 is a rear perspective view of an example ankle joint motion assist device 100. FIG. 3 is a view illustrating a state in which an example ankle joint motion assist device 100 is worn on a user's body. FIG. 4 is an exploded perspective view of an example ankle joint motion assist device 100.

An ankle joint motion assist device 100 may be mounted on a foot portion, an ankle portion, and/or a calf portion of a user (U) to assist exercise and movement of an ankle joint. Specifically, the ankle joint motion assist device 100 may be implemented as a structure capable of roll rotation and/or pitch rotation in response to two-degree-of-freedom movement of the ankle joint, to assist eversion and inversion operations and/or dorsiflexion and plantar flexion operations in the ankle joint of the user.

Referring to FIGS. 1 to 4, an ankle joint motion assist device 100 may include a foot accommodating portion 110, a driver 120, a connector 150, a linker 160, and a binding unit 170.

The foot accommodating portion 110 may be provided to accommodate a user's foot. The foot accommodating portion 110 may be coupled to the connector 150. For example, the foot accommodating portion 110 may be fixedly coupled to a first connector 151 of the connector 150. The foot accommodating portion 110 may be rotatably connected to the driver 120 through the connector 150 about two axes, perpendicular to each other. For example, the foot accommodating portion 110 may be connected to the first connector 151 of the connector 150, and may be provided to be rotatable together with the first connector 151 within a predetermined angle range around two axes with respect to the driver 120.

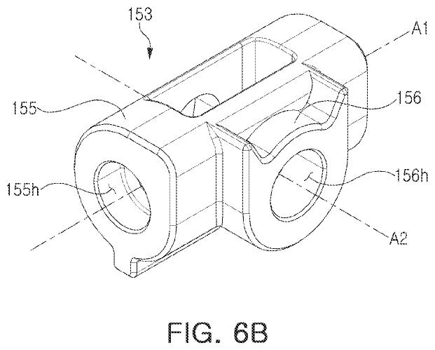

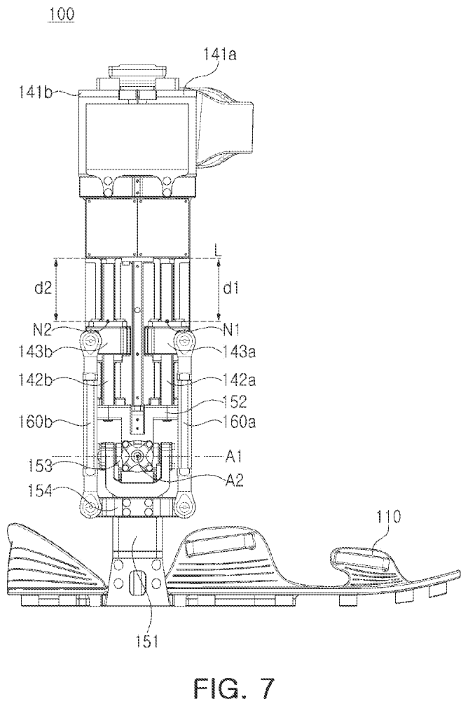

The driver 120 may provide driving force to rotate the foot accommodating portion 110. The driver 120 may be coupled to the connector 150. For example, the driver 120 may be fixedly coupled to a second connector 152 of the connector 150. At least a portion of the driver 120 may be connected (e.g., indirectly connected) to the first connector 151 of the connector 150 via the linker 160. Linear motion generated in the driver 120 may be transmitted to the first connector 151 through the linker 160, and may be converted into rotational movement of the foot accommodating portion 110. An operation of rotating the foot accommodating portion 110 by driving the driver 120 will be described in detail below with reference to FIGS. 7 to 9.

The driver 120 may include a base plate 130 and a pair of linear motor modules 140. For example, the driver 120 may be provided in a structure in which the pair of linear motor modules 140 are coupled to the base plate 130, and the pair of linear motor modules 140 may be driven independently of each other.

The base plate 130 may support the pair of linear motor modules 140. The base plate 130 may be coupled to the connector 150. The base plate 130 may be fixedly coupled to the second connector 152 of the connector 150. For example, a lower end portion of the base plate 130 may be coupled to the second connector 152 using various coupling means. The bay base plate 130 may move integrally with the second connector 152. When the user wears the ankle joint motion assist device 100, the base plate 130 may be located on a side portion of the user's calf, and may partially contact the calf to support wearing of the ankle joint motion assist device 100.

The pair of linear motor modules 140 may include a first linear motor module 140a and a second linear motor module 140b, and the first linear motor module 140a and the second linear motor module 140b may include the same components. For example, the pair of linear motor modules 140 may include a first linear motor module 140a and a second linear motor module 140b, in which the same components are assembled, and may be coupled to the base plate 130 in parallel.

The first linear motor module 140a and the second linear motor module 140b may include a motor 141, a shaft 142, and a nut 143, respectively. The motor 141 may rotate the shaft 142, and the nut 143 may move linearly on the shaft 142 in response to the rotation of the shaft 142. For example, the first linear motor module 140a may include a first motor 141a, a first shaft 142a, and a first nut 143a, and the second linear motor module 140b may include a second motor 141b, a second shaft 142b, and a second nut 143b. As described above, the pair of linear motor modules 140 and the components included therein may have the same configuration, but may be referred to separately as ‘first ˜’ and ‘second ˜’ for convenience of explanation.

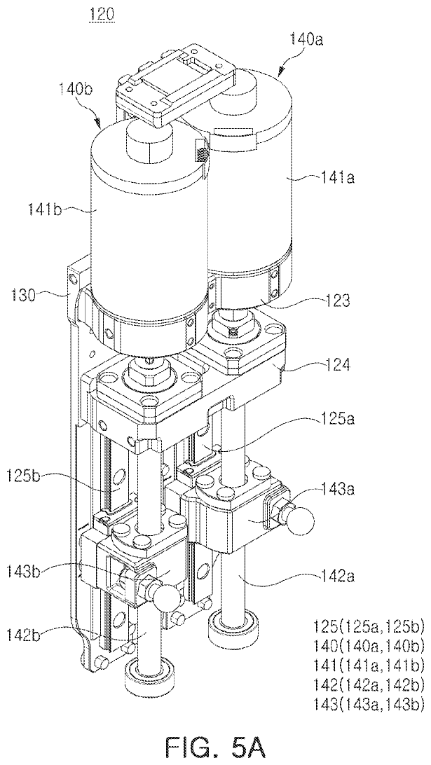

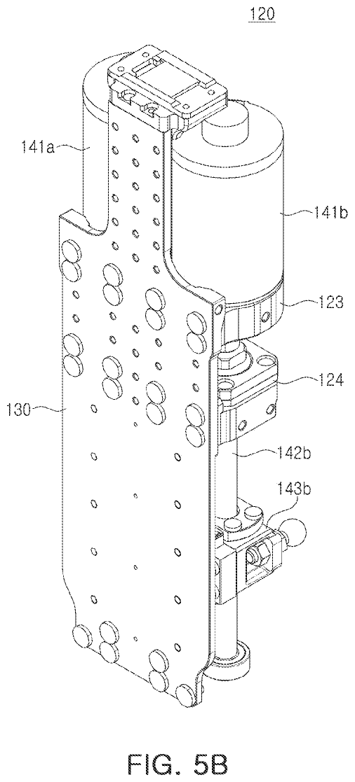

The shaft 142 of each of the pair of linear motor modules 140 may be coupled to the connector 150. A first shaft 142a of the first linear motor module 140a and a second shaft 142b of the second linear motor module 140b may be rotatably coupled to the second connector 152 of the connector 150. For example, a lower end portion of the first shaft 142a and a lower end portion of the second shaft 142b may be rotatably coupled to the second connector 152, to rotate the first shaft 142a and the second shaft 142b by driving the first motor 141a and the second motor 141b. A specific structure of the pair of linear motor modules 140 will be described in detail below with reference to FIGS. 5A and 5B.

The driver 120 may further include a main controller 121 controlling an overall operation of the ankle joint motion assist device 100, and a motor driver 122 controlling a motor. The main controller 121 may be coupled to the side portion of the motor 141, and the motor driver 122 may be coupled to the linear motor module 140 to be located between the motor 141 and the shaft 142. The motor driver 122 may include a first motor driver corresponding to a first motor 141a and a second motor driver corresponding to a second motor 141b.

As illustrated in FIG. 3, the driver 120 may be located between the user's ankle and knee when the user wears the ankle joint motion assist device 100. As the linear motor module 140, which is a component having a large weight proportion, is located above the ankle, weight felt by the user and load acting on a hip joint may be reduced, and comfort of wearing may be improved. The linear motor module 140 may be located further away from the ankle as a stroke distance increases. In the linear motor module 140, when a length of the shaft 142 increases, a length at which the nut 143 moves linearly may increase, thereby increasing the stroke distance. The connector 150 may be coupled to the foot accommodating portion 110 and located adjacent to the user's ankle, and as the length of the shaft 142 connected to the second connector 152 increases, a position of the motor 141 may rise. A maximum height of the motor 141 may not exceed the knee. A range of motion (ROM) or rotation range of the foot accommodating portion 110 may be determined or adjusted according to the stroke distance of the linear motor module 140. The ankle joint motion assist device 100 of the present disclosure may adjust the range of motion to suit the user by changing a length of the shaft 142.

The connector 150 may connect the foot accommodating portion 110 and the driver 120 to be rotatable with respect to each other. The connector 150 may include a first connector 151 to which the foot accommodating portion 110 is fixedly coupled, a second connector 152 to which the driver 120 is fixedly coupled, and a joint portion 153 connecting the first connector 151 and the second connector 152. The first connector 151 and the second connector 152 may be connected to be rotatable, relative to each other, through the joint portion 153. For example, the first connector 151 and the second connector 152 may be connected by the joint portion 153, and may be connected to enable relative rotation around two axes, perpendicular to each other.

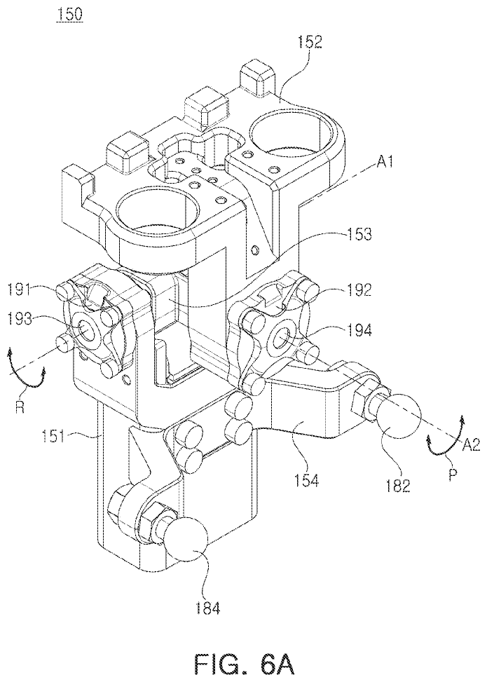

The connector 150 may further include a support portion 154 supporting the linker 160. The support portion 154 may be fixedly coupled to the first connector 151 of the connector 150. The support portion 154 may move integrally with the first connector 151. The support portion 154 may include a link ball 180 to which at least a portion of the linker 160 may be rotatably connected. A specific structure of the connector 150 will be described in detail below with reference to FIGS. 6A and 6B.

The linker 160 may connect at least a portion of the driver 120 and at least a portion of the connector 150, and may transmit driving force generated by the driver 120 to the connector 150. The linker 160 may be coupled to the linear motor module 140 and the support portion 154. In the linker 160, an upper end portion may be rotatably connected to the nut 143 of the linear motor module 140 (e.g., 162), and a lower end portion may be rotatably connected to the support portion 154 (e.g., 163), such that linear motion generated by the drive portion 120 may be transmitted to the first connector 151 and converted into rotational movement of the first connector 151 and the foot accommodating portion 110.

The linker 160 may include a first linker 160a transmitting driving force of the first linear motor module 140a to the first connector 151, and a second linker 160b transmitting driving force of the second linear motor module 140b to the first connector 151. The first linker 160a and the second linker 160b may include a rod 161 extending in a predetermined length, an upper socket 162 coupled to an upper end portion of the rod 161, and a lower socket 163 coupled to a lower end portion of the rod 161. For example, the first linker 160a may include a first rod 161a, a first upper socket 162a, and a first lower socket 163a, and the second linker 160b may include a second rod 161b, a second upper socket 162b, and a second lower socket 163b. According to various examples, the first linker 160a and the second linker 160b may have the same length, or may be provided to have different lengths.

The sockets 162 and 163 of the linker 160 may be rotatably coupled to the link ball 180. At least a portion of the link ball 180 may be accommodated in the sockets 162 and 163 of the linker 160 to perform rotational or pivot movement relative to the sockets 162 and 163. For example, the link ball 180 may rotate 360 degrees around a center of the link ball 180 in the sockets 162 and 163. In the first linker 160a, the first upper socket 162a may be rotatably coupled to a first link ball 181 formed on the first nut 143a, and the first lower socket 163a may be rotatably coupled to a second link ball 182 formed on the support portion 154, to connect the first linear motor module 140a and the first connector 151. In the second linker 160b, the second upper socket 162b may be rotatably coupled to a third link ball 183 formed on the second nut 143b, and the second lower socket 163b may be rotatably coupled to a formed fourth link ball 184 formed on the support portion 154, to connect the second linear motor module 140b and the first connector 151. For example, the link ball 180 and the sockets 162 and 163 may form a ball joint.

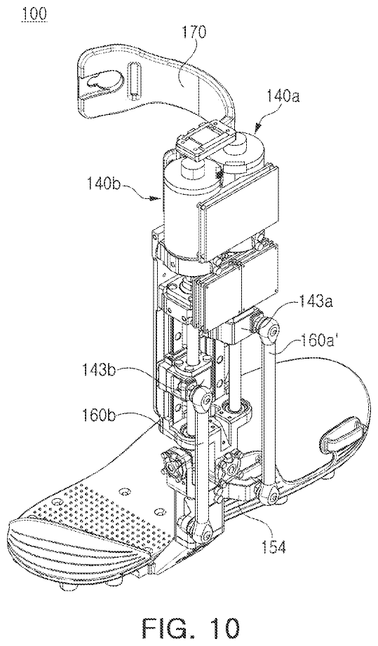

The linker 160 may be detachably coupled to the linear motor 141 and the support portion 154 using a ball joint structure. The sockets 162 and 163 of the linker 160 may be detachably coupled to the link ball 180. For example, the sockets 162 and 163 of the linker 160 may be coupled to or separated from the link ball 180 by external force applied by the user. In an ankle joint motion assist device 100, as the linker 160 is configured to be detachable, it is possible to replace/change the linker 160 having a length optimized for rotation range of the user's ankle. The replacement/change of the linker 160 will be described in detail below with reference to FIGS. 10 to 12.

The binding unit 170 may stably bind the ankle joint motion assist device 100 to the user's body. The binding unit 170 may surround and support the user's calf and/or shin. A shape and a position of the binding unit 170 are not limited to an illustrated example, and may be applied to various shapes and positions that may fully or partially support the user's calf and/or shin. For example, the binding unit 170 may include a band or a belt, and may be formed of an elastic material.

FIG. 5A is a front perspective view of a driver 120 of an example ankle joint motion assist device 100. FIG. 5B is a rear perspective view of a driver 120 of an example ankle joint motion assist device 100.

FIG. 5A may be a view illustrating the driver 120 separated from the ankle joint motion assist device 100 illustrated in FIG. 1, and FIG. 5B may be a view illustrating the driver 120 separated from the ankle joint motion assist device 100 illustrated in FIG. 2. FIGS. 5A and 5B may be views in which a main controller 121 and a motor driver 122 are omitted.

Referring to FIGS. 5A and 5B, a driver 120 of an ankle joint motion assist device 100 may include a base plate 130, a linear motor module 140, a motor support member 123, a shaft support member 124, and a guide rail 125. The linear motor module 140 may be coupled to the base plate 130 through the motor support member 123, the shaft support member 124, and the guide rail 125. Hereinafter, when describing the driver 120 with reference to FIGS. 5A and 5B, contents overlapping the previous description will be omitted.

The linear motor module 140 may include a first linear motor module 140a and a second linear motor module 140b, arranged in parallel. The first linear motor module 140a may include a first motor 141a, a first shaft 142a, and a first nut 143a, and the second linear motor module 140b may include a second motor 141b, a second shaft 142b, and a second nut 143b. A nut 143 may fit on a shaft 142, and may move linearly on the shaft 142 based on rotation of the shaft 142. Although not illustrated, threads may be formed on an outer peripheral surface of the shaft 142, and threads corresponding to the threads of the shaft 142 may be formed on an inner peripheral surface of the nut 143. Therefore, the shaft 142 and the nut 143 may be screw connected to each other, and the nut 143 may move linearly on the shaft 142 by rotation of the shaft 142.

The linear motor module 140 may be implemented using a ball screw motor. For example, the shaft 142 may be a ball screw, the nut 143 may be a ball nut, and a plurality of balls may be disposed between the shaft 142 and the nut 143. The linear motor module 140 is not limited to the ball screw motor, and may be implemented using various types of actuators converting rotational movement of the shaft 142 into linear movement of the nut 143.

The motor support member 123 may be coupled to the base plate 130. For example, the motor support member 123 may be coupled to a front surface of the base plate 130 and disposed adjacent to an upper end portion of the base plate 130. The motor support member 123 may support a motor 141. The first motor 141a and the second motor 141b may be coupled to the motor support member 123. For example, the first motor 141a and the second motor 141b may be accommodated on and coupled to an upper portion of the motor support member 123. At least a portion of the first motor 141a and at least a portion of the second motor 141b may extend through the motor support member 123 toward the shaft support member 124.

The shaft support member 124 may be coupled to the base plate 130. For example, the shaft support member 124 may be coupled to the front surface of the base plate 130, and may be disposed at a certain interval in a downward direction from the motor support member 123. The shaft support member 124 may support the shaft 142. The first shaft 142a and the second shaft 142b may be coupled to the shaft support member 124. For example, the first shaft 142a and the second shaft 142b may be rotatably coupled to the shaft support member 124 while passing through the shaft support member 124. The first shaft 142a and the second shaft 142b may pass through the shaft support member 124, and may be coupled to the first motor 141a and the second motor 141b, respectively, and may be rotated by operations of the first motor 141a and the second motor 141b. For example, the first shaft 142a and the second shaft 142b may be configured such that upper end portions thereof are connected to an axis of the first motor 141a and an axis of the second motor 141b, to rotate together with the axis of the first motor 141a and the axis of the second motor 141b. In addition, the first shaft 142a and the second shaft 142b may be configured such that lower end portions thereof are rotatably connected to the second connector (e.g., the second connector 152 of FIGS. 1 to 4) to rotate relative to the connector (e.g., the connector 150 of FIGS. 2 to 4).

The guide rail 125 may be coupled to the base plate 130. For example, the guide rail 125 may be coupled to the front surface of the base plate 130, and may be disposed below the shaft support member 124. The guide rail 125 may guide linear movement (or sliding) of the nut 143 of the linear motor module 140. The guide rail 125 may be disposed in parallel with the shaft 142, and may extend in a longitudinal direction of the shaft 142. The guide rail 125 may include a first guide rail 125a to which the first nut 143a of the first linear motor module 140a is slidably coupled, and a second guide rail 125b to which the second nut 143b of the second linear motor module 140b is slidably coupled. The first guide rail 125a and the second guide rail 125b may be arranged in parallel, corresponding to arrangement of the first linear motor module 140a and the second linear motor module 140b.

Hereinafter, an operation in which the nut 143 moves linearly on the shaft 142 according to driving of the motor 141 will be described. When the motor 141 operates based on control of a main controller 121 and/or control of a motor driver 122, the shaft 142 may rotate together with an axis of the motor 141. When the shaft 142 rotates, the nut 143 screwed to the shaft 142 may be slidably coupled to the guide rail 125, and may be separated from the rotation of the shaft 142, such that the nut 143 may move linearly along the guide rail 125 on the shaft 142. For example, the nut 143 may move in a direction closer to the shaft support member 124, when the shaft 142 rotates in one direction, and may move in a direction away from the shaft support member 124 when the shaft 142 rotates in an opposite direction.

FIG. 6A is a perspective view of a connector 150 of an example ankle joint motion assist device 100. FIG. 6B is a perspective view of a joint portion 153 of a connector 150.

FIG. 6A may be a view illustrating a connector 150 separated from the ankle joint motion assist device 100 illustrated in FIG. 1, and FIG. 6B may be a view illustrating a joint portion 153 separated from the connector 150 illustrated in FIG. 6A.

Referring to FIGS. 6A and 6B, a connector 150 of an ankle joint motion assist device 100 may include a first connector 151, a second connector 152, a support portion 154, and a joint portion 153. Hereinafter, when describing the connector 150 with reference to FIGS. 5A and 5B, contents overlapping the previous description will be omitted.

The joint portion 153 may connect the first connector 151 and the second connector 152 to be rotatable with respect to each other. The first connector 151 and the second connector 152 may rotate about respective rotation axes thereof, based on the joint portion 153. For example, the joint portion 153 may include a universal joint, but is not limited thereto.

The first connector 151 may be rotatably coupled to the joint portion 153 about a first rotation axis A1. The second connector 152 may be rotatably coupled to the joint portion 153 about a second rotation axis A2, perpendicular to the first rotation axis A1. For example, the first connector 151 may rotate about the first rotation axis A1 relative to the joint portion 153, and the second connector 152 may rotate about the second rotation axis A2 relative to the joint portion 153. The rotation of the first connector 151 and the rotation of the second connector 152 with respect to the joint portion 153 may be performed independently of each other.

The joint portion 153 may include a first portion 155 extending in a predetermined length in a direction of the first rotation axis A1 and having first connectors 151 rotatably coupled to both sides, and a second portion 156 protruding or extending from a portion of the first portion 155 in a direction of the second rotation axis A2 and to which the second connector 152 is rotatably coupled. The joint portion 153 may be disposed between opposing side walls of the first connector 151.

The joint portion 153 may include coupling holes 155h and 156h into which coupling members 191 and 192 are inserted. The first connector 151 may be rotatably coupled to the joint portion 153 through a first coupling member 191. A first coupling hole 155h into which the first coupling member 191 is inserted and coupled may be formed in the first portion 155 of the joint portion 153. The second connector 152 may be rotatably coupled to the joint portion 153 through a second coupling member 192. A second coupling hole 156h into which the second coupling member 192 is inserted and coupled may be formed in the second portion 156 of the joint portion 153.

Sensors 193 and 194 may be disposed in the first coupling member 191 and the second coupling member 192. For example, a first sensor 193 may be disposed in the first coupling member 191, and a second sensor 194 may be disposed in the second coupling member 192. The first sensor 193 may sense a degree to which the first connector 151 rotates about the first rotation axis A1 with respect to the joint portion 153, to detect a rotation angle and/or position information of the first connector 151. The second sensor 194 may sense a degree to which the second connector 152 rotates about the second rotation axis A2 with respect to the joint portion 153, to detect rotation angle and/or position information of the second connector 152. The first sensor 193 and the second sensor 194 may include an encoder, for example, a rotary magnetic encoder, but is not limited thereto.

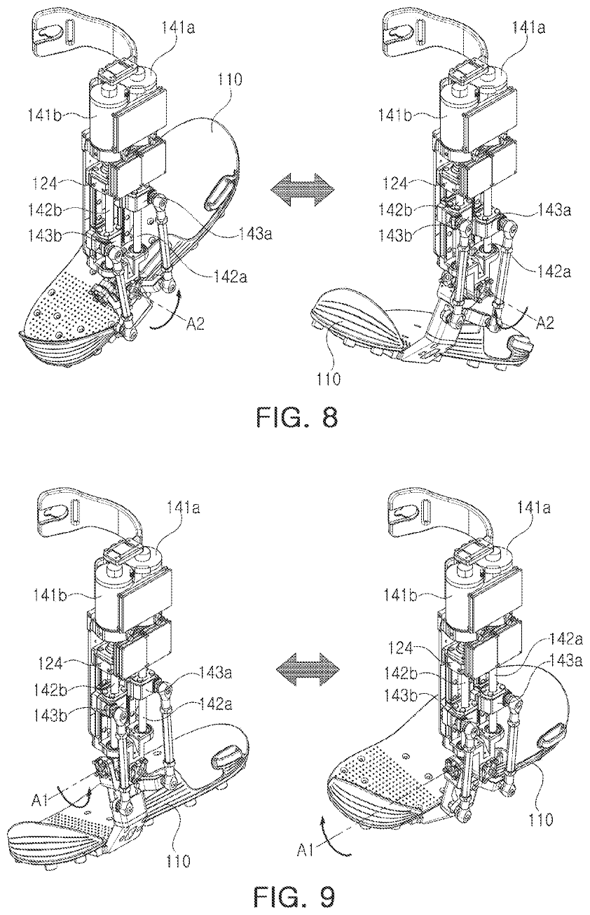

The connector 150 may connect a driver 120 and a foot accommodating portion 110, as the second connector 152 is fixedly coupled to the driver 120 and the foot accommodating portion 110 is fixedly coupled to the first connector 151. According to this, the first connector 151 may rotate about the first rotation axis A1 with respect to the joint portion 153 while the second connector 152 and the joint portion 153 are relatively fixed. As the first connector 151 rotates about the first rotation axis A1, a roll operation R (e.g., see FIG. 9) of the foot accommodating portion 110 may be performed, which may assist eversion and inversion operations of an ankle. In addition, the first connector 151 and the joint portion 153 may rotate together about the second rotation axis A2 with respect to the second connector 152 while the second connector 152 is relatively fixed. As the first connector 151 rotates about the second rotation axis A2, a pitch operation P (e.g., see FIG. 8) of the foot accommodating portion 110 may be performed, which may assist dorsiflexion and plantar flexion operations of the ankle.

FIG. 7 is a plan view of a front surface of an example ankle joint motion assist device 100. FIG. 8 is a view illustrating a pitch operation of an ankle joint motion assist device 100. FIG. 9 is a view illustrating a roll operation of an ankle joint motion assist device 100.

FIG. 7 illustrates a basic state of an ankle joint motion assist device 100 in which a driver 120 is not driven, FIG. 8 illustrates a state in which a pitch operation is performed in both directions based on the basic state of FIG. 7, FIG. 9 illustrates a state in which a roll operation is performed in both directions based on the basic state of FIG. 7, respectively.

Referring to FIGS. 7 to 9, in an ankle joint motion assist device 100, a pitch operation (e.g., an operation illustrated in FIG. 8) may be performed, as a foot accommodating portion 110 and a first connector 151 rotate about a second rotation axis A2 with respect to a driver 120 and a second connector 152, and a roll operation (e.g., an operation illustrated in FIG. 9) may be performed, as the foot accommodating portion 110 and the connector 151 rotate about a first rotation axis A1 with respect to the driver 120 and the second connector 152. The pitch and roll operations may be performed independently. For example, only one of the pitch operation or the roll operation may be performed, or the pitch operation and the roll operation may be performed simultaneously.

The pitch operation and the roll operation may be performed by transmitting force to a support portion 154, as a first nut 143a and a second nut 143b linearly move along a first shaft 142a and a second shaft 142b in a first linear motor module 140a and a second linear motor module 140b, respectively. When the first nut 143a and the second nut 143b move linearly in opposite directions, as a first linker 160a and a second linker 160b transmit force to both end portions of the support portions 154 connected respectively thereto in opposite directions, and rotate with respect to a link ball of a nut 143 and the support portion 154, the first connector 151 and the foot accommodating portion 110 may rotate about the first rotation axis A1. When the first nut 143a and the second nut 143b move linearly in the same direction, as the first linker 160a and the second linker 160b transmit force to both end portions of the support portions 154 connected respectively thereto in the same direction and rotate with respect to the link ball of the nut 143 and the support portion 154, the first connector 151 and the foot accommodating portion 110 may rotate about the second rotation axis A2.

In the pitch operation and roll operation, a pitch angle (e.g., a pitch rotation degree) and a roll angle (e.g., a roll rotation degree) may be determined based on a direction and a distance in which the first nut 143a and the second nut 143b have moved. Specifically, the pitch angle and the roll angle may be determined by a distance between the first nut 143a and a shaft support member 124, and a distance between the second nut 143b and the shaft support member 124. For example, in FIG. 7, the pitch angle and the roll angle of the foot accommodating portion 110 may be determined by a length d1 between a line L and a point N1 and a length d2 between the line L and a point N2.

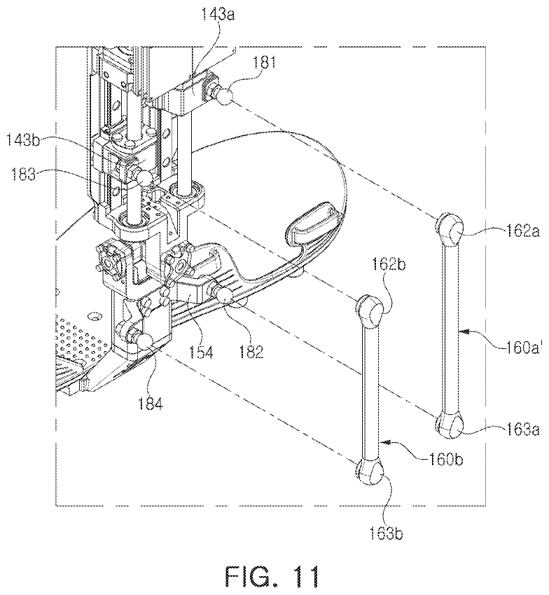

As illustrated in FIG. 7, in a basic state of the ankle joint motion assist device 100, d1 and d2 may have the same specified length. The basic state of the ankle joint motion assist device 100 is not limited to an illustrated example. If linkers 160 are configured to have different lengths, d1 and d2 may be different (e.g., see FIGS. 10 and 11). Hereinafter, a process in which the pitch operation and the roll operation are performed will be described based on a case on which d1 and d2 have the same first length, but the description may be equally applied even when d1 and d2 are different.

First, with reference to FIGS. 7 and 8, the pitch operation will be described.

In the basic state, when a first motor 141a and a second motor 141b is driven to move the first nut 143a in a direction toward the shaft support member 124 or the first motor 141a (hereinafter referred to as an upward direction)) by a first distance and the second nut 143b moves in a direction away from the shaft support member 124 or the second motor 141b (hereinafter referred to as a downward direction) by the first distance, a pitch operation for the foot accommodating portion 110 may be performed in a forward direction. In this case, d1 may have a second length, smaller than the first length, d2 may have a third length, larger than the first length, and a difference between the first length and the second length may be equal to a difference between the first length and the third length. In this case, in the pitch operation in a forward direction, the pitch angle may be defined as a positive number (+).

In the basic state, when the first motor 141a and the second motor 141b is driven to move the first nut 143a in the downward direction by the second distance and the second nut 143b moves in the upward direction by the second distance, a pitch operation for the foot accommodating portion 110 may be performed in a backward direction. In this case, d1 may have a fourth length, larger than the first length, d2 may have a fifth length, smaller than the first length, and a difference between the first length and the fourth length may be equal to a difference between the first length and the fifth length. In this case, in the pitch operation in a backward direction, the pitch angle may be defined as a negative number (−).

When the first distance at which the first nut 143a and the second nut 143b move in performing a pitch operation at a positive angle is equal to the second distance at which the first nut 143a and the second nut 143b move in performing a pitch operation at a negative angle, an absolute value of a pitch angle, e.g., a degree of rotation, may be the same. However, this is illustrative and does not limit the present disclosure, and depending on the example, the absolute value of the pitch angle may be different even when the first distance and the second distance are the same.

Next, with reference to FIGS. 7 and 9, the roll operation will be described.

In the basic state, when the first motor 141a and the second motor 141b equally move the first nut 143a and the second nut 143b in the upward direction by the third distance, a roll operation for the foot accommodating portion 110 may be performed in an outward direction. In this case, d1 and d2 have the same length as a sixth length, smaller than the first length. In this case, in the roll operation in an outward direction, the roll angle may be defined as a positive number (+).

In the basic state, when the first motor 141a and the second motor 141b equally move the first nut 143a and the second nut 143b in the downward direction by the fourth distance, a roll operation for the foot accommodating portion 110 may be performed in an inward direction. In this case, d1 and d2 have the same length as a seventh length, larger than the first length. In this case, in the roll operation in an inward direction, the roll angle may be defined as a negative number (−).

Even when the third distance at which the first nut 143a and the second nut 143b move in performing a roll operation at a positive angle is equal to the fourth distance at which the first nut 143a and the second nut 143b move in performing a roll operation at a negative angle, an absolute value of a roll angle, e.g., a degree of rotation, may be different. However, this is illustrative and does not limit the present disclosure, and depending on the example configuration, the absolute value of the roll angle may be the same even when the third distance and the fourth distance are the same.

Hereinafter, when the ankle joint motion assist device 100 is in the basic state, assuming that d1 and d2 are the same as 56.5 mm, how a pitch operation and/or a roll operation is performed in a certain direction depending on a change in lengths d1 and d2 will be explained. However, numerical values mentioned in the following description are illustrative and do not limit the present disclosure.

In the basic state of d1=d2=56.5 mm, a pitch angle and a roll angle may be 0°.

When the first nut 143a and the second nut 143b move with d1=d2>56.5 mm (e.g., a right drawing of FIG. 9), a pitch angle may be 0°, a roll angle may be a predetermined negative angle, and a pitch operation may be performed in an inward direction. When the first nut 143a and the second nut 143b move with d1=d2<56.5 mm (e.g., a left drawing of FIG. 9), the pitch angle may be 0°, the roll angle may be a predetermined positive angle, and a roll operation may be performed in an outward direction.

When the first nut 143a and the second nut 143b move with d1<56.5 mm<d2 in the same distance (e.g., a left drawing of FIG. 8), a roll angle may be 0°, a pitch angle may be a predetermined amount, and a pitch operation may be performed in a forward direction. When the first nut 143a and the second nut 143b move with d1>56.5 mm>d2 in the same distance (e.g., a right drawing of FIG. 8), a roll angle may be 0°, a pitch angle may be a predetermined negative angle, and a pitch operation may be performed in a backward direction.

When the first nut 143a and the second nut 143b move with d1<62.19 mm<d2 in the same distance, a roll angle may be about −10°, and a pitch operation may be performed in a forward direction. When the first nut 143a and the second nut 143b move with d1>62.19 mm>d2 in the same distance, a roll angle may be about −10°, and a pitch operation may be performed in a backward direction.

When the first nut 143a and the second nut 143b move with d1<50.07 mm<d2 in the same distance, a roll angle may be about 10°, and a pitch operation may be performed in a forward direction. When the first nut 143a and the second nut 143b move with d1>50.07 mm>d2 in the same distance, a roll angle may be about 10°, and a pitch operation may be performed in a backward direction.

FIG. 10 is a perspective view of an example ankle joint motion assist device 100. FIG. 11 is a view illustrating an operation of replacing a linker 160 in an ankle joint motion assist device 100.

FIGS. 10 and 11 illustrate examples in which linkers 160 of an ankle joint motion assist device 100 are provided to have different lengths. For example, it can be understood that the examples illustrated in FIGS. 10 and 11 are configured that an existing first linker 160a is separated from an ankle joint motion assist device 100, as previously described with reference to FIGS. 1 to 9, and a relative longer first linker 160a′ is mounted.

Referring to FIGS. 10 and 11, in an ankle joint motion assist device 100, a linker 160 may be detachably connected to a linear motor module 140 and a support portion 154 in a ball joint manner, and the linker 160 may thus be replaced or changed. For example, a linker 160 and link balls 181, 182, 183, and 184 may be configured that a spring seal is disposed between sockets 162a, 163a, 162b, and 163b and the link balls 181, 182, 183, and 184 for easy attachment/detachment, and is coupled thereto.

A first linker 160a′ and a second linker 160b may have different lengths. For example, the first linker 160a′ may be formed to be longer than the second linker 160b. FIGS. 10 and 11 illustrate an example in which the first linker 160a′ is replaced with a relative long component, but is illustrative, and the first linker 160a′ may be replaced with a relative short component or the second linker 160b may be replaced with a component having a different length.

At least one of the first linker 160a′ or the second linker 160b may be replaced with a component having an appropriate length corresponding to a range of motion of an ankle desired by a user. When the first linker 160a′ and the second linker 160b are different from each other, a pitch operation will be affected, and an operation of the ankle joint motion assist device 100 may be optimized to fit a pitch angle range desired by the user.

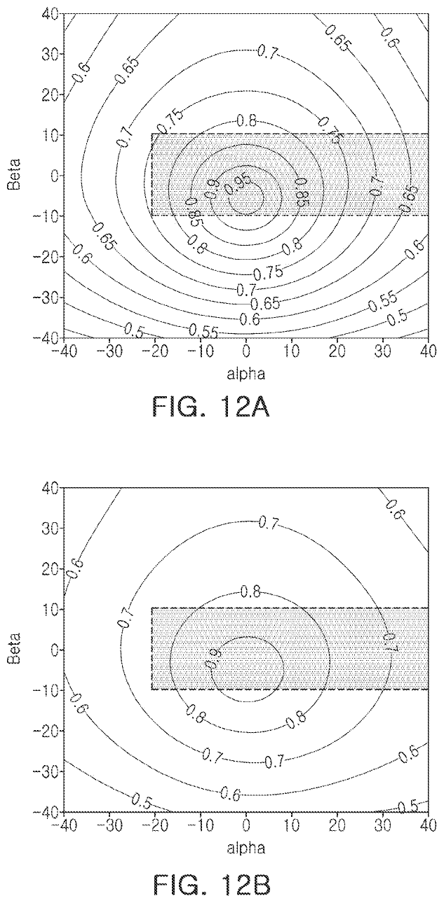

FIGS. 12A and 12B are graphs illustrating a condition number for a case on which lengths of linkers 160 are the same and a condition number for a case on which lengths of linkers 160 are different, in an ankle joint motion assist device 100 according to the present disclosure.

FIGS. 12A and 12B are graphs illustrating condition numbers according to a pitch angle and a roll angle, when linkers 160 in an ankle joint motion assist device 100 have predetermined lengths. Hereinafter, in describing FIG. 12, FIGS. 1 and 10 will be referred to together.

FIG. 12A is a graph of a condition number for a case on which a length of a first linker 160a is equal to a length of a second linker 160b, as in FIG. 1, and FIG. 12B is a graph of a condition number for a case on which a length of a first linker 160a′ is larger than a length of a second linker 160b, as in FIG. 10. In the graphs of FIGS. 12A and 12B, a numeral displayed on a contour represents ‘1/condition number’, the ‘1/condition number’ has a numerical range from 0 to 1, and, when the condition number is 1, performance may mean the best. For example, FIG. 12A is a graph illustrating ‘1/condition number’ according to a pitch angle and a roll angle when a first linker 160a and a second linker 160b are about 114 mm, FIG. 12B is a graph illustrating ‘1/condition number’ according to a pitch angle and a roll angle when a first linker 160a′ is about 125 mm and a second linker 160b is about 114 mm. The above numerals are illustrative, and do not limit the present disclosure.

In the graphs of FIGS. 12A and 12B, alpha and beta represent a pitch angle and a roll angle, respectively, and units thereof are °. In this case, as previously explained, a negative alpha means a pitch operation in a backward direction, a positive alpha means a pitch operation in a forward direction, a negative beta means a roll operation in an inward direction, and a positive beta means a roll operation in an outward direction.

The condition number may be a number indicating how much a rate of change in output value of a function for a small rate of change in input value of the function, and may be an indicator that measures sensitivity of the function. In the graphs of FIGS. 12A and 12B, the condition number may indicate how much a change in pitch angle or roll angle of a foot accommodating portion 110 and a first connector 151 with respect to linear movement displacement of a linear motor module 140 at a predetermined pitch angle or roll angle, and may indicate a smaller amount of sensitivity as the condition number is closer to 1. For example, as the condition number is closer to 1, a change in angle may not increase due to linear movement displacement, and as the condition number becomes smaller than 1, a change in angle may significantly increase due to linear movement displacement. For example, when the condition number is 1, the device may be interpreted as having the best performance.

In the graphs of FIGS. 12A and 12B, as the condition number is closer to 1, when minute linear movement displacement is generated in the linear motor module 140, rotation of the foot accommodating portion 110 may be also slightly generated to have low probability of overfitting and be robust against errors. Therefore, precise control is possible. As the condition number differs from 1, when minute linear movement displacement is generated in the linear motor module 140, rotation of the foot accommodating portion 110 may be unintentionally large generated to have high probability of overfitting and sensitivity to errors. Therefore, precise control is difficult.

Comparing the graphs of FIGS. 12A and 12B, when a range of motion (ROM) of the pitch operation is required to be about −20° to 40°, in a case in which the first linker 160a′ is longer than the second linker 160b, a condition number between about 30° and 40° may be closer to 1, than a case in which the length of the first linker 160a is equal to the length of the second linker 160b. For example, when the first linker 160a′ is longer than the second linker 160b, sensitivity may decrease and precise control is possible between about 30° and 40°. Therefore, it may be further optimized in a range of motion of about −20° to 40°.

The graphs of FIGS. 12A and 12B illustrate analysis results of one example to explain that an ankle joint motion assist device 100 may be optimized to suit a range of motion of a user's ankle by adjusting a length of a linker 160. However, the present disclosure is not limited by the above-mentioned values.

According to an example configuration, two-degree-of-freedom movement of an ankle may be implemented using a pair of linear motor modules arranged in parallel.

Additionally, according to an example configuration, a driver may be designed to be located above an ankle, thereby reducing load felt by a user and improving wearing comfort.

In addition, according to an example configuration, as a linker is provided to be detachable, a length of the linker may be changed/replaced to suit a range of motion of an ankle, and assistance optimized for the range of motion may be provided.

While example configurations have been illustrated and described above, it will be apparent to those skilled in the art that modifications and variations could be made without departing from the scope of the present disclosure as defined by the appended claims.

Additionally, in example configurations of the present disclosure, some components may be deleted, and the components of each embodiment may be combined with each other.

An aspect of the present disclosure is to provide a wearable ankle joint motion assist device that enables two-degree-of-freedom movement of an ankle and provides assistance optimized for a user's range of motion.

According to an aspect of the present disclosure, an ankle joint motion assist device includes a foot accommodating portion on which a user's foot is accommodated; a driver connected to the foot accommodating portion and providing driving force for rotation of the foot accommodating portion; and a connector rotatably connecting the foot accommodating portion and the driver, wherein the connector includes a first connector to which the foot accommodating portion is coupled, and a second connector to which the driver is coupled, the first connector is rotatably connected to the second connector about a first rotation axis and a second rotation axis, perpendicular to each other, the driver includes a pair of linear motor modules respectively connected to the first connector through a pair of linkers, and both end portions of the pair of linkers are rotatably connected to the pair of linear motor modules and the first connector.

The connector may further include a joint portion connecting the first connector and the second connector, wherein the first connector may be rotatably connected to the joint portion about the first rotation axis, and the second connector may be rotatably connected to the joint portion about the second rotation axis.

The first connector may be connected to the joint portion through a first coupling member, and the second connector may be connected to the joint portion through a second coupling member, wherein the first coupling member may include a first sensor detecting a degree to which the first connector rotates about the first rotation axis with respect to the joint portion, and the second coupling member may include a second sensor detecting a degree to which the second connector rotates about the second rotation axis with respect to the joint portion.

The pair of linear motor modules may include a first linear motor module and a second linear motor module, arranged in parallel and driven independently, wherein the first linear motor module may include a first motor, a first shaft configured to rotate together with the first motor, and a first nut moving linearly on the first shaft by rotation of the first shaft, and the second linear motor module may include a second motor, a second shaft configured to rotate together with the second motor, and a second nut moving linearly on the second shaft by rotation of the second shaft.

An upper end portion of the first shaft and an upper end portion of the second shaft may be connected to and rotate integrally about the first motor and the second motor, respectively, and a lower end portion of the first shaft and a lower end portion of the second shaft may be rotatably connected to the second connector, respectively.

The first linear motor module and the second linear motor module may include a ball screw motor.

The pair of linkers may include a first linker of which both end portions are connected to the first nut of the first linear motor module and one side of the first connector, and a second linker of which both end portions are connected to the second nut of the second linear motor module and the other side of the first connector.

The both end portions of the first linker and the both end portions of the second linker may be detachably connected to the pair of linear motor modules and the first connector, respectively, corresponding thereto, in a ball joint manner.

The both end portions of the first linker and the both end portions of the second linker may be detachably connected to the pair of linear motor modules and the first connector, respectively, corresponding thereto.

Linear movement of the first nut occurring in the first linear motor module may be transmitted to the first connector through the first linker, and linear movement of the second nut occurring in the second linear motor module may be transmitted to the first connector through the second linker, wherein at least one of the linear motion of the first nut or the linear motion of the second nut may be transmitted to the first connector, to cause rotational movement of the first connector.
the first linker and the second linker may be configured to have the same length or different lengths. A length of the first linker and a length of the second linker may affect a rotation amount of the first connector with respect to a linear movement amount of the first nut and a linear movement amount of the second nut.

The length of the first linker and the length of the second linker may be determined based on a range of motion of the user's ankle, wherein at least one of the first linker or the second linker is replaceable in accordance with the range of motion.

When a length of the first linker is equal to a length of the second linker, the first nut and the second nut may be located on the same height from a ground, in a basic state in which the foot accommodating portion is horizontal to the ground.

When a length of the first linker is greater than a length of the second linker, the first nut may be located higher from a ground than the second nut, in a basic state in which the foot accommodating portion is horizontal to the ground.

When the first nut and the second nut move linearly in the same direction, the foot accommodating portion may rotate around the first rotation axis with respect to the second connector together with the first connector.

When the first nut and the second nut move linearly in opposite directions, the foot accommodating portion may rotate about the second rotation axis with respect to the second connector together with the first connector and the joint portion.

A degree to which the foot accommodating portion rotates about the first rotation axis or the second rotation axis may be determined based on a linear movement distance of the first nut and the second nut.

According to an aspect of the present disclosure, an ankle joint motion assist device includes a foot accommodating portion on which a user's foot is accommodated; a driver connected to the foot accommodating portion and providing driving force for roll movement and pitch movement of the foot accommodating portion; and a connector rotatably connecting the foot accommodating portion and the driver, wherein the connector includes a first connector to which the foot accommodating portion is coupled, a second connector to which the driver is coupled, and a joint portion rotatably connecting the first connector and the second connector about a first rotation axis and a second rotation axis, perpendicular to each other, the roll operation of the foot accommodating portion is performed as the first connector rotates about the first rotation axis with respect to the second connector, and the pitch operation of the foot accommodating portion is performed as the first connector rotates about the second rotation axis with respect to the second connector.

The driver may include a base plate, and a pair of linear motor modules coupled to the base plate to be arranged in parallel, wherein the pair of linear motor modules may be located between the user's ankle and knee.

What is claimed is:

1. A device comprising:
a foot accommodating portion configured to accommodate a foot of a user;
a driver connected to the foot accommodating portion and configured to provide driving force for rotation of the foot accommodating portion; and
a connector rotatably connecting the foot accommodating portion and the driver,
wherein:
the connector comprises a first connector to which the foot accommodating portion is coupled, and a second connector to which the driver is coupled,
the first connector is rotatably connected to the second connector about a first rotation axis and a second rotation axis, the first rotation axis and second rotation axis being substantially perpendicular to each other,
the driver comprises a pair of linear motor modules connected to the first connector through a pair of linkers, and
end portions of the pair of linkers are rotatably connected to the pair of linear motor modules and the first connector.

2. The device of claim 1, wherein:
the connector further comprises a joint portion connecting the first connector and the second connector,
the first connector is rotatably connected, about the first rotation axis, to the joint portion, and
the second connector is rotatably connected, about the second rotation axis, to the joint portion.

3. The device of claim 2, wherein:
the first connector is connected to the joint portion via a first coupling member,
the second connector is connected to the joint portion via a second coupling member,
the first coupling member comprises a first sensor configured to detect a degree to which the first connector rotates about the first rotation axis with respect to the joint portion, and
the second coupling member comprises a second sensor configured to detect a degree to which the second connector rotates about the second rotation axis with respect to the joint portion.

4. The device of claim 2, wherein the pair of linear motor modules comprises a first linear motor module and a second linear motor module, arranged in parallel and driven independently,
wherein the first linear motor module comprises a first motor, a first shaft configured to rotate together with the first motor, and a first nut configured to move linearly on the first shaft by rotation of the first shaft, and
the second linear motor module comprises a second motor, a second shaft configured to rotate together with the second motor, and a second nut configured to move linearly on the second shaft by rotation of the second shaft.

5. The device of claim 4, wherein an upper end portion of the first shaft is connected to and is configured to rotate integrally with the first motor, and an upper end portion of the second shaft is connected to and is configured to rotate integrally with the second motor, and
a lower end portion of the first shaft and a lower end portion of the second shaft are rotatably connected to the second connector.

6. The device of claim 4, wherein each of the first linear motor module and the second linear motor module comprise a ball screw motor.

7. The device of claim 4, wherein the pair of linkers comprises:
a first linker of which a first end portion is connected to the first nut of the first linear motor module and a second end portion is connected to one side of the first connector; and
a second linker of which a first end portion is connected to the second nut of the second linear motor module and a second end portion is connected to another side of the first connector.

8. The device of claim 7, wherein the first and second end portions of the first linker and the first and second end portions of the second linker are detachably connected, in a ball joint manner, to the pair of linear motor modules and the first connector.

9. The device of claim 7, wherein the first and second end portions of the first linker and the first and second end portions of the second linker are detachably connected to the pair of linear motor modules and the first connector.

10. The device of claim 7, wherein linear movement of the first nut occurring in the first linear motor module is transferred to the first connector through the first linker, and
linear movement of the second nut occurring in the second linear motor module is transferred to the first connector through the second linker,
wherein at least one of the linear movement of the first nut or the linear movement of the second nut is transferred to the first connector, to cause rotational movement of the first connector.

11. The device of claim 7, wherein the first linker and the second linker are configured to have substantially similar lengths.

12. The device of claim 7, wherein a length of the first linker and a length of the second linker affect a rotation amount of the first connector associated with a linear movement amount of the first nut and a linear movement amount of the second nut.

13. The device of claim 12, wherein the length of the first linker and the length of the second linker are based on a range of motion of an ankle of the user,
wherein at least one of the first linker or the second linker is replaceable in accordance with the range of motion.

14. The device of claim 11, wherein the first nut and the second nut are located at substantially similar heights from a ground, in a state in which the foot accommodating portion is horizontal to the ground, based on a length of the first linker being substantially equal to a length of the second linker.

15. The device of claim 11, wherein the first nut is located higher from a ground than the second nut, in a state in which the foot accommodating portion is horizontal to the ground, based on a length of the first linker being greater than a length of the second linker.

16. The device of claim 4, wherein the foot accommodating portion is configured to rotate, together with the first connector and with respect to the second connector, around the first rotation axis, based on the first nut and the second nut moving linearly in substantially similar directions.

17. The device of claim 16, wherein the foot accommodating portion is configured to rotate, together with the first connector and with respect to the second connector, about the second rotation axis, based on the first nut and the second nut moving linearly in substantially opposite directions.

18. The device of claim 17, wherein a degree to which the foot accommodating portion rotates about the first rotation axis or the second rotation axis is determined based on a linear movement distance of the first nut and the second nut.

19. A device comprising:
a foot accommodating portion configured to accommodate a foot of a user;
a driver connected to the foot accommodating portion and configured to provide driving force for roll movement and pitch movement of the foot accommodating portion; and
rotatably the foot a connector connecting accommodating portion and the driver,
wherein:
the connector comprises a first connector to which the foot accommodating portion is coupled, a second connector to which the driver is coupled, and a joint portion rotatably connecting the first connector and the second connector about a first rotation axis and a second rotation axis, the first rotation axis and the second rotation axis being substantially perpendicular to each other,
the foot accommodating portion is configured to perform the roll movement as the first connector rotates, with respect to the second connector, about the first rotation axis, and
the foot accommodating portion is configured to perform the pitch movement as the first connector rotates, with respect to the second connector, about the second rotation axis.

20. The device of claim 19, wherein the driver comprises a base plate, and a pair of linear motor modules coupled to the base plate and arranged in parallel, and
wherein the pair of linear motor modules are located between an ankle of the user and a knee of the user.
